(19) United States
(12) Patent Application Publication
(10) Pub. No.: US 2007/0131794 A1
(43) Pub. Date: Jun. 14, 2007

(54) Multifunction spray gun

(76) Inventors: Shin-Bing Lai, Gui-Shan (TW); Chun-N Tseng, Gui-Shan (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 11/298,456

(22) Filed: Dec. 12, 2005

(51) Int. Cl. A62C 13/62

(52) U.S. Cl. 239/304; 239/310; 239/526

(57) ABSTRACT

A spray gun with containers can be supplemented with additives, which are dispersed into the water flow and sprayed out together. A pistol shaped gun has a spout at the front end of the gun and at least one container inside the gun for storing additives. A mixing duct inside the gun communicates with the spout for sufficiently stirring the additives within the water flow. An inlet hose is led from the second end of the gun to the mixing duct. The inlet hose is kept an eccentric position in opposite to the spout with a distance. Branched tubes are connected among the inlet hose and the containers respectively. Valves inside the branched tubes are coordinated with the button outside the gun to control the water flow.

### FIELD OF THE INVENTION

The present invention is related to a multifunction spray gun having a container applied fluid pressure to eject gasified liquid, for example, water combined with additives in the container and then being sprayed out as a fluid.

### BACKGROUND OF THE INVENTION

The jet of water from the hose, in usual, is used to clean the floor or objects, or gardening, watering flowers; a water gun is required to pump out the water. However, when cleaning objects; sometimes, powdered detergents must be diluted and combined with the water in advance, then the diluted detergent is accommodated to spray out on the objects. After that, the objects can be cleansing by washing with much clean water sprayed out on them promptly. Much water impinging the face of the object can wash out the dirt off and detergents cleaned away at the same time. Nevertheless, a time consuming act, or an extra spray gun, is requested for the additives are first dispersed to the objects before the water gun is applied to clean the objects. Due to the detergents is required to spray out in advance and then to spray out water, at least, as mentioned above two steps or two guns are required to add to the options of clean-up work. Work efficiency being lowered, the user is further bothered by the time consuming, burdensome operations. Accordingly, persons skilled in the art has invented a gun can mix detergent and water to slush around, recorded in the patent document such as TWM247295 entitled “Extended Pole adapted with spray gun can be filled with detergents and water at the same time” assigned to Chen, Chin-Yuan on 21 Oct. 2004. Which is aimed to solve the problem as mentioned above.

A container of aforesaid TWM247295 having detergents passed from the outlet to the vacuum channel disperses to the clean water flow and then sprayed out from the spout. Owing to the detergents are insufficiently stirred within the water, part of detergents are not diluted with a diminishing clean effect, further being harmful to the surface of the objects. How to improve only one container for diluting the added detergents sufficiently within the flowing water is concerned by the present invention.

### SUMMARY OF THE INVENTION

Accordingly, the present invention is primarily aimed to dilute the additives into the water sufficiently and then sprayed out together. Rather, the flow of additives is under control with accuracy, which is convenient for varying with the concentration of the additive in the water flow.

Furthermore, the present invention is to provide at least one kind of additive, so the water flowed into the container is to combine with one or more additives. It is not restricted to only one kind of additive.

Point against aforesaid problems, the present invention is aimed to provide a multifunction spray gun, which is characterized in that: a pistol shaped gun (1), a spout (20) at a first end for spraying out water flow, in the middle of the gun, at least one container (12,13) for storing additives, a duct (14) formed at the front end of the gun for mixing water flow and the additives sufficiently; an inlet hose (16) from a second end of the gun to the duct (14), the inlet hose (16) fitting eccentric with respect to the spout and kept a gap from the spout; branched tubes (161,162) are connected between the inlet hose (16) and the container (12,13); valves (163,164) disposed inside the branched tubes are to open or close the path between the container and the inlet hose, a button (17) disposed outside the gun controls the volume of the water flow.

A multifunction spray gun as mentioned above, in that, the container can be divided into a dominant container (12), and at least one subordinate container (13).

A multifunction spray gun as mentioned above, in that, a first stopper (141) disposed in front of the inlet hose inside the mixing duct (14).

A multifunction spray gun as mentioned above, in that, a second stopper (142) disposed inside the mixing duct (14) is interlocked with and opposite to the first stopper (141).

A multifunction spray gun as mentioned above, in that, the spout (20) of the gun is engaged with a sprinkle nozzle can regulate the sprinkling water.

A multifunction spray gun as mentioned above, in that, the gun can be shaped in the form of a tube (1′).

A multifunction spray gun as mentioned above, in that, a number of orifices (161a, 162a) in the branched tubes (161, 162) for drawing in or out the pressurized water.

A multifunction spray gun as mentioned above, in that, lids (121,131) are exposed outside the container of the gun.

In contrast with the prior art, in practice the present invention can be achieved the merits and the benefits as following:

After pressurized water is drawn through the inlet hose (16) to the gun, water flowing with pressure to disperse the additives from the containers (12,13) to the mixing duct (14), after stirring sufficiently and evenly with the water flow, which is sprayed out from the spout (20). Alternate of the valves (161b, 162b) in the branched tubes (161,162) at open or closed positions, the pressurized water can be, selected whether added with additives, sprayed out with high pressure. At least two kinds of flush jet, or slush around ways can be performed in the present invention.

In practice a dominant container (12) with at least one subordinate container (13) can be allowed to store at least two kinds of different additives or pharmaceuticals respectively according to the “recipe”, or at least two kinds of additives or pharmaceuticals diluted within water in advance. Such as the dominant container (12) keeps foam, the dilution with water can be applied to fire fighting or car washing. The detergents stored in the subordinate container (13) can be combined with the clean water to clean up. Or the foam, detergents are combined together with the water flow to spray out to flush. Otherwise, the container can be used to store the nutrients, which can be combined with water flow for watering flower. Usage feasibility of the present invention is varied from gardening to flushing. Next, opening the lids (121, 131) exposed outside the gun, the additives can be added to the container any time.

The stoppers (141,142) disposed in the mixing duct (14) can be applied to disperse the combined sprinkler foam (water and the additives) through high pressure flushing and evenly stirring activities to achieve the sufficiently combined effects. A nozzle (11) can be applied to regulate the sprinkling water. By means of the button (17), either the water flow being open or closed, or the volume of the water flow can be adjusted or regulated.

### BRIEF DESCRIPTION OF THE DRAWINGS

FIG. 1: a schematic view of the appearance of the spray gun of the present invention;

FIG. 2: a cross section view of the spray gun of the present invention;

FIG. 3: a schematic view of regulating the flow between the inlet hose and the mixing duct;

FIG. 3A: a schematic view of the valve movements in the branched tube;

FIG. 4: a schematic view of adjusting the nozzle for changing the fan shaped spread out sprinkling water flow;

FIG. 5: a schematic view of the alternate embodiment of the present invention; and

FIG. 6: a cross section view of the alternate embodiment of the present invention.

Glossary

| | | | |
|---|---|---|---|
| (1) | Gun | (141) | First stopper |
| (1′) | Tube | (142) | Second stopper |
| (11) | Nozzle | (15) | Grip |
| (12) | Dominant container | (15′) | Grip |
| (121) | Subordinate container | (16) | Inlet hose |
| (131) | Lid | (161) | Branched tube |
| (14) | Mixing duct | (161a) | Orifices |
| (161b) | Valve | (171) | Button |
| (161c) | Rotating button | (17′) | Lever |
| (162) | Branched tube | (18) | Partition |
| (162a) | Orifices | (19) | Container |
| (162b) | Valve | (20) | Spout |
| (162c) | Rotating button | (D) | distance |

### DETAILED DESCRIPTION OF THE PREFERRED EMBODIMENTS

The description is described in detail according to the appended drawings as following:

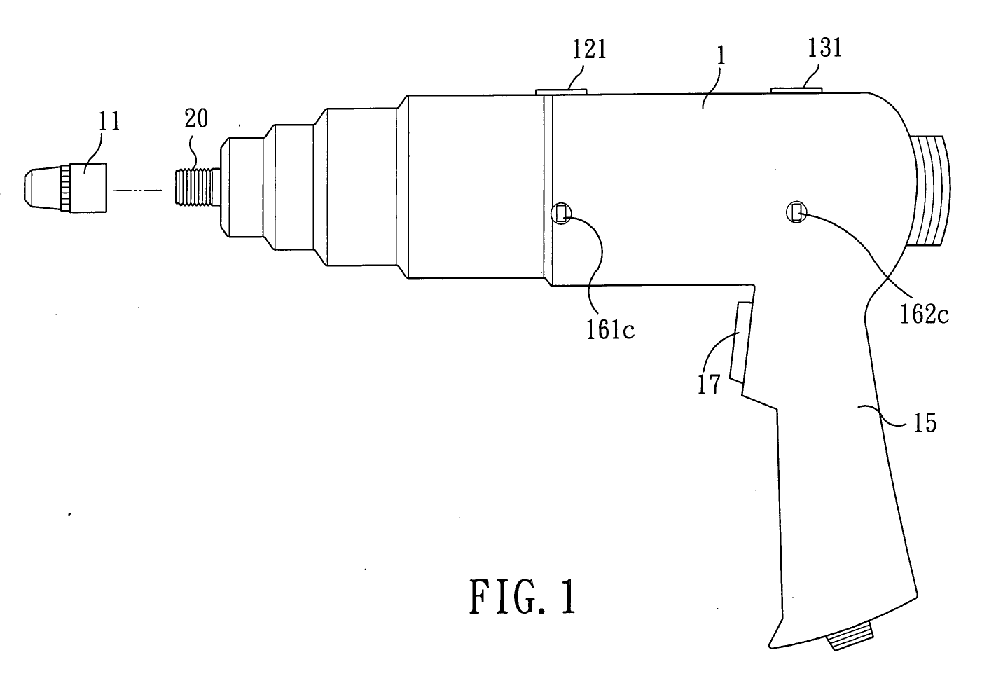

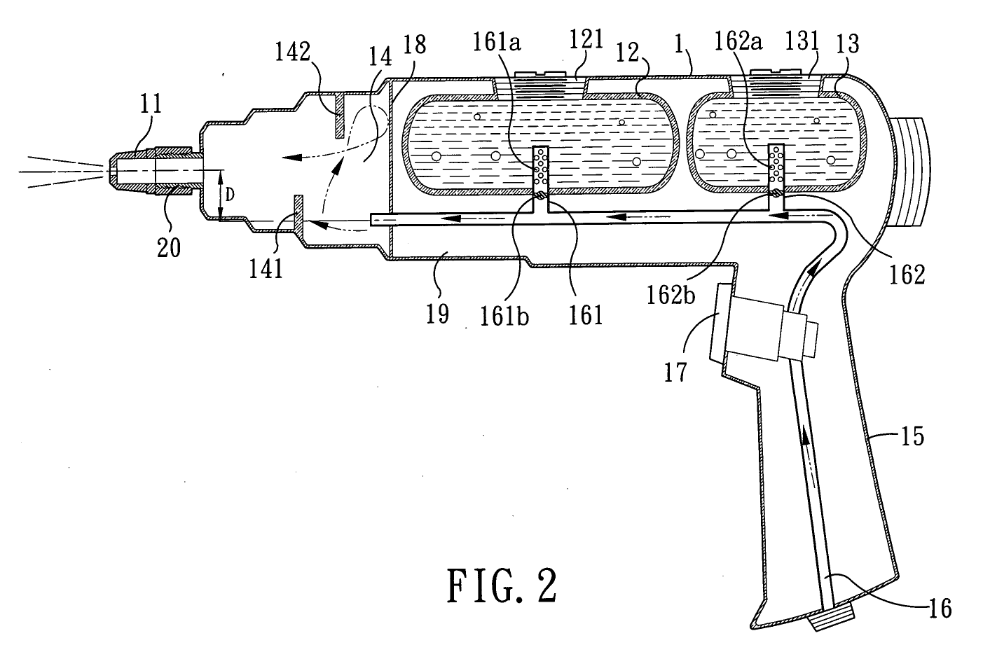

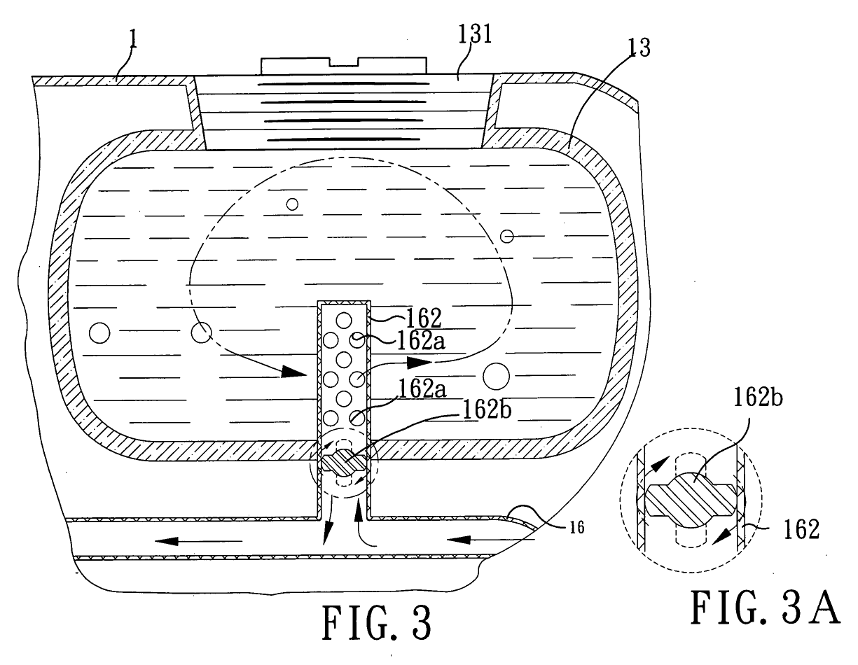

As shown in FIGS. 1 and 2, a schematic view and a cross section view of the appearance of the multifunction gun are illustrated. In which, the spray gun is shaped as a pistol like gun (1). A spout (20) is installed at a front end of the gun (1); the spout (20) further has a nozzle (11) installed to the front end of the spout. The gun is constructed of a pistol shaped gun (1), at least one container disposed in the middle of the gun (In FIGS. 2 and 3, containers (12,13) are illustrated), the additives can be supplemented to the container. A mixing duct (14) installed inside the front end of the gun, which can be used to disperse and dilute the additives within the water flow. An inlet hose (16) is adapted to the bottom end inside the grip further extended to the mixing duct (15). Branched tubes are connected among the inlet hose (16), containers (12,13), and the mixing duct (14). Rather, the valves (161b, 162b) disposed inside the branched tubes are in control of the branched tubes to open or close. A nozzle (11) installed outside the front end of the gun (1), a button (17) installed outside the gun (1) for the user to regulate the volume of the water flow, and close/open the water flow.

As mentioned above, the container can be divided into a dominant container (12) and at least one subordinate container (13). (In FIGS. 1,2, only one subordinate container is shown.) Each container can be supplemented with the same or different additives, and the lids (121,131) are exposed outside the dominant and subordinate containers (12,13). Via the opening of the lids (121,131), the dominant and subordinate containers (12,13) can be stuffed or filled with the additives. Next, the inlet hose (16) can be connected to the inner side of the dominant and subordinate containers (12,13) by branched tubes (161,162). A number of orifices (161a,162a) are formed along the branched tube portions inside the containers. Valves (161b,162b) inside the branched tubes (161,162) are used to open/close and regulate the flow of additives. Each one of said valves (161b, 162b) is allowed to coordinate with each of the buttons (161c, 162c) respectively. In other words, the buttons (161c, 162c) can be applied to change the rotation angle of the valves (161b, 162b).

As mentioned above, the mixing duct (14) is sectioned by a partition (18) to separate the dominant container (12) from the subordinate container (13). Thus, the dominant and subordinate containers (12,13) and inlet hose (16) are situated within the container (19). But the end portion of the inlet hose (16) can pass the partition (18) to the mixing duct (14). The inlet hose (16) is not in connection with the nozzle (20). Conversely, the axis of the inlet hose (16) is in eccentric position opposite to, not in alignment with, the axis of the nozzle (20). A gap is kept between the axes of the inlet hose and the nozzle. Therefore, a distance (D) is defined between the two axes of inlet hose and the nozzle. By means of the distance (D), the water flow from the inlet hose (16) can be delivered into the mixing duct, first generating a torrent and then being sprayed out by the nozzle (20).

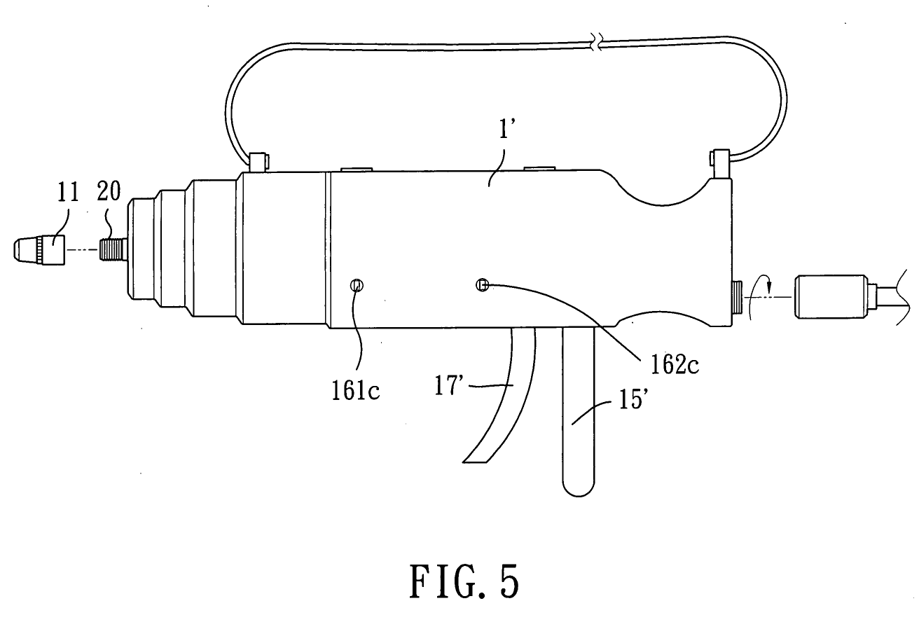

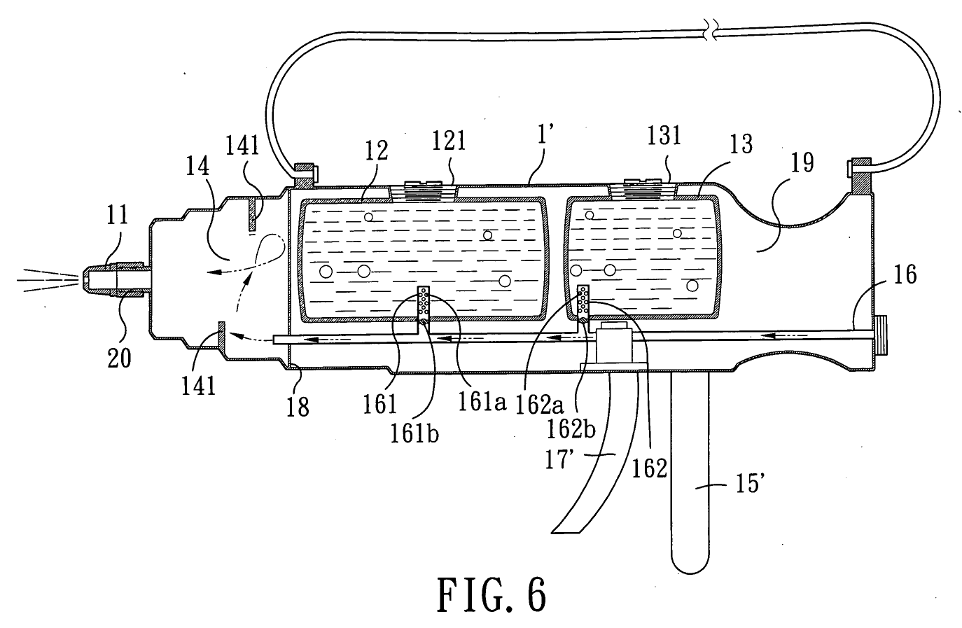

For evenly and sufficiently stirring the flow combined with the additives in the mixing duct (14), in this alternate embodiment, at least one stopper is disposed to the containers. Such as two stoppers exemplified and illustrated in the FIGS. 5 and 6 are designated as the first and second stoppers (141,142) respectively. The locations of the stoppers are arranged as the first stopper is situated lower and near the front end, the second stopper situated higher and near the rear end. Due to the first stopper (141) is located in front of the opening of the inlet hose (16), when the additives dilution within the water flow is sprayed out through the opening of the inlet hose (16), water impinges the first stopper (141) directly. During water impinging, water impinges the surface of the first stopper swirls backward and upward instantly, hindered by a second stopper (142) water swirls again. After swirling twice, the additives are first diluted within water completely, and then water flows to the spout (20); finally, water sprays out through the nozzle (11).

As shown in FIGS. 3 and 3A, schematic views of water flow between the subordinate container (13) and the inlet hose (16) are illustrated. In that, pressurized water is led in the inlet hose (16), when valve (162b) as the solid line indicated is closed, the additives retained in the subordinate container (13) do not flow out. Pressurized water will flow to the mixing duct directly, and then being sprayed out from the spout (20). Conversely, when valve (162b) as the dashed line indicated is open, the additives in the subordinate container(13) pass the orifices (162a) to the inlet hose (16) first disperse into water, and then the dilution with water flows to the mixing duct (14), and then being stirred and combined sufficiently; finally, being sprayed out from the spout (20). Regulating water flow between the dominant container (12) and the inlet hose (16) is operated in the same manner as mentioned above, there is no need to made the description redundant to be filled with repetition.

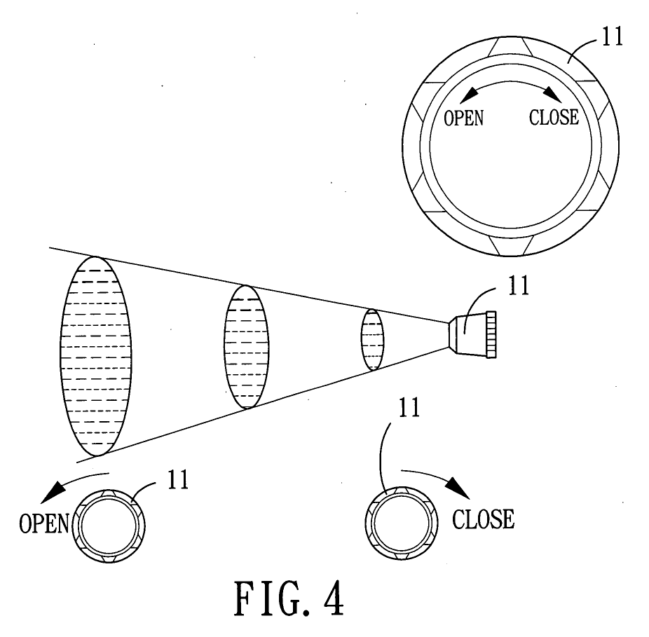

As shown in FIG. 4, a schematic view of the nozzle (11) is illustrated. In that, the nozzle (11) is installed to the front end of the spout (20). The user turns the nozzle (11) to open or close, further to adjust or regulate the water volume when water sprayed out to form the fan shaped area as required. The nozzle (11) mentioned here is applied to spraying out water at the front end of the spout (20). It is a prior art, no need to discuss more details about it.

As shown in FIG. 5, a schematic view of the appearance of the alternate embodiment of the present invention is illustrated. In which, the multifunction spray gun is shaped as a tube (1′). The spout (20) at the front end of the tube (1′) is combined with a nozzle (11). A grip (15′) is extended below the rear portion of the tube (1′). A cambered level (17′) for controlling the water flow is installed to the front of the grip (15′).

As shown in FIG. 6, the tube (17′) has a dominant container (12), a subordinate container (13), a mixing duct (14), and an inlet hose (16) from the rear end of the tube (1′) to the mixing duct (14) inside the tube (1′); said inlet hose (16) is in communication with the dominant container (12) and the subordinate container (13) by branched tubes (161,162) respectively. Furthermore, the branched tubes (161,162) are led in the dominant container (12) and the subordinate container (13) with a number of orifices (161a, 162a) formed through the wall of the branched tubes led in the containers, valves (161b, 162b) are disposed inside the branched tubes to control the inlet hose (16) whether being in communication with the containers (12,13) or not. Rather, the first, second stoppers (141,142) can be disposed in the mixing duct (14), the first and second stoppers (141,142) are interlocked in an up and down relationship as described in the first embodiment. There is no need to discuss more in detail.

What is claim claimed:

1. A multifunction spray gun comprising:
a pistol shaped gun (1), a spout (20) at a first end for spraying out water flow, in the middle of the gun, at least one container (12,13) for storing additives, a mixing duct (14) formed at the front end of the gun for mixing water flow and the additives sufficiently;
an inlet hose (16) from a second end of the gun to the duct (14), the inlet hose (16) fitting eccentric with respect to the spout and kept a gap from the spout;
branched tubes (161,162) are connected between the inlet hose (16) and the container (12,13);
valves (163,164) disposed inside the branched tubes are to open or close the path between the container and the inlet hose;
a button (17) disposed outside the gun controls the volume of the water flow.

2. A multifunction spray gun according to claim 1, in that, the container can be divided into a dominant container (12), and at least one subordinate container (13).

3. A multifunction spray gun according to claim 1, in that, a first stopper (141) disposed in front of the inlet hose inside the mixing duct (14).

4. A multifunction spray gun according to claim 1, in that, a second stopper (142) disposed inside the mixing duct (14) is interlocked with and opposite to the first stopper (141).

5. A multifunction spray gun according to claim 1, in that, the spout (20) of the gun is engaged with a sprinkle nozzle can regulate the sprinkling water.

6. A multifunction spray gun as mentioned above, in that, the gun can be shaped in the form of a tube (1′).

7. A multifunction spray gun as mentioned above, in that, a number of orifices (161a, 162a) in the branched tubes (161, 162) for drawing in or out the pressurized water.

8. A multifunction spray gun as mentioned above, in that, lids (121,131) are exposed outside the container of the gun.
